(19) United States
(12) Patent Application Publication
(10) Pub. No.: US 2024/0278892 A1
(43) Pub. Date: Aug. 22, 2024

(54) MODULAR BELT TENSIONING MECHANISM AND POWERHEAD STRUCTURE OF A MARINE PROPULSION SYSTEM

(71) Applicant: Flux Marine Ltd., Bristol, RI (US)

(72) Inventors: Benjamin Sorkin, Melville, NY (US); Linden Zlotea, Jamaica Plain, MA (US)

(21) Appl. No.: 18/634,264

(22) Filed: Apr. 12, 2024

Related U.S. Application Data
(63) Continuation of application No. PCT/US22/46735, filed on Oct. 14, 2022.
(60) Provisional application No. 63/256,408, filed on Oct. 15, 2021.

(51) Int. Cl. B63H 20/14; B63H 23/02

(52) U.S. Cl. CPC B63H 20/14; B63H 2023/0216

(57) ABSTRACT

A marine propulsion apparatus includes a first drive shaft, a lifting plate fixed relative to the first drive shaft, a midsection top collar. The apparatus includes a lower unit attached to the midsection top collar, the lower unit having a second drive shaft, wherein the midsection top collar is fixed relative to the second drive shaft. The apparatus includes a power transmission component rotatably coupling the first drive shaft to the second drive shaft, wherein the power transmission component is continuously disposed over the first drive shaft and the second drive shaft and configured to rotate about the first and second drive shafts. The apparatus includes one or more lifting screws coupling the lifting plate to the midsection top collar, wherein adjusting the one or more lifting screws changes a distance between the lifting plate and the midsection top collar, thereby adjusting a tension of the power transmission component.

### CROSS-REFERENCE TO RELATED APPLICATIONS

This application is a Continuation of, and claims the benefit of priority under 35 USC 120 to Patent Cooperation Treaty Application No. PCT/US22/46735 filed Oct. 14, 2022, which claims the benefit of priority to U.S. Provisional Patent Application No. 63/256,408, filed on Oct. 15, 2021, the entirety of which is hereby incorporated by reference.

### FIELD OF THE INVENTION

Embodiments of the present disclosure generally relate to marine propulsion systems. More specifically, the present disclosure relates to a modular structure that enables power transmission through a belt and supports powertrain components.

### BACKGROUND

Marine propulsion engines have historically been categorized into three general types: inboard marine propulsion systems, outboard marine propulsion systems, and sterndrive (or inboard/outdrive marine propulsion systems). An outboard engine generally comprises a powerhead with a prime mover, a lower unit or gearcase that houses a propeller and shaft, and a midsection that provides physical connection between the powerhead and lower unit while allowing a power transmission device to transfer power from the prime mover to propeller shaft. The entirety of the outboard engine mounts to the transom of a boat and can be removed.

A variety of power transmission methods exist, including drive shaft, belt, chain, or direct drive transmission arrangements. Sterndrive and outboard marine propulsion systems traditionally use a drive shaft with a set of right-angle bevel gears to transmit rotational power from a prime mover to the propeller. An additional gear set is used in the case of combustion engines to enable reversing rotation. Drive shafts with bevel gears at the bottom are particularly conducive to a vertical power output from the powerhead, allowing a large engine to be centered above the lower unit. However, drive shafts also suffer from higher frictional losses than other methods. Direct drive systems are popular with many small electric outboard systems, where the motor is mounted in the lower unit and is directly connected to the propeller. This is possible because of the smaller size of electric motors as compared to combustion engines, but this engine geometry presents issues for larger, more powerful, motors as the frontal area and hydrodynamic shape of submerged motor would cause significant drag.

Synchronous belts have become strong and durable, enabling potential use in higher power marine engine transmissions. Implementation of such belt technologies present challenges in physical housing arrangements and mechanical assembly. Three of the most significant hurdles to overcome when using a belt drive in an outboard engine are the requirement that the powerhead provides a horizontal power output, the need to keep the belt under tension, and the tendency for the belt to shift along pulleys if shafts are not properly aligned. Tension is added to the belt by increasing the distance it must travel between pulleys, either by physically moving the pulleys apart, or by deflecting the belt with an idler pulley. Despite the added friction, idler pulleys have so far been ubiquitous for belt drives in marine propulsion applications due to the difficulty of moving either the propeller shaft or the primary mover and powerhead without sacrificing either shaft alignment or waterproofing.

Embodiments of the present disclosure are intended to address the above challenges as well as others.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings

To achieve these and other advantages and in accordance with the purpose of the disclosed subject matter, as embodied and broadly described, the disclosed subject matter includes a marine propulsion apparatus includes a first drive shaft, a lifting plate fixed relative to the first drive shaft, a midsection top collar. The apparatus includes a lower unit attached to the midsection top collar, the lower unit having a second drive shaft, wherein the midsection top collar is fixed relative to the second drive shaft. The apparatus includes a power transmission component rotatably coupling the first drive shaft to the second drive shaft, wherein the power transmission component is continuously disposed over the first drive shaft and the second drive shaft and configured to rotate about the first and second drive shafts. The apparatus includes one or more lifting screws coupling the lifting plate to the midsection top collar, wherein adjusting the one or more lifting screws changes a distance between the lifting plate and the midsection top collar, thereby adjusting a tension of the power transmission component.

To achieve these and other advantages and in accordance with the purpose of the disclosed subject matter, as embodied and broadly described, the disclosed subject matter includes a marine propulsion apparatus includes a first drive shaft, a lifting plate fixed at a first distance relative to the first drive shaft, a midsection top collar. The apparatus includes a lower unit, the lower unit comprising a second drive shaft, wherein the midsection top collar is fixed at second distance relative to the second drive shaft. The apparatus includes a power transmission component rotatably coupling the first drive shaft to the second drive shaft, the power transmission component configured to rotate the second drive shaft. The apparatus includes one or more lifting screws disposed between the lifting plate and the midsection top collar, the one or more lifting screws rotatably coupled to the lifting plate and the midsection top collar, defining a third distance therebetween, wherein rotating the one or more lifting screws alters the third distance, thereby altering a tension of the power transmission component.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE SEVERAL VIEWS OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 illustrates an isometric view of an outboard motor according to embodiments of the present disclosure.

FIG. 2 a block diagram representing component level interactions between the propulsion system as a whole and the dual strut lower unit according to embodiments of the present disclosure.

FIG. 3 illustrates a partial side view of the dual strut and lower unit bullet architecture taken generally below the line 1-1 of FIG. 1 according to embodiments of the present disclosure.

FIG. 4 illustrates a partial front view taken generally below the line 1-1 of FIG. 1 according to embodiments of the present disclosure.

FIG. 5 illustrates a cross-sectional side view taken generally below the line 3-1 of FIG. 3 according to embodiments of the present disclosure.

FIG. 6 illustrates a cross-sectional top view taken generally below the line 3-1 of FIG. 3 according to embodiments of the present disclosure.

FIG. 7 illustrates a cross-sectional front view taken generally below the line 3-1 of FIG. 3 according to embodiments of the present disclosure.

FIG. 8 illustrates a schematic representation of an outboard power transmission system according to embodiments of the present disclosure.

FIG. 9 illustrates a schematic representation of a belt-drive transmission system according to embodiments of the present disclosure.

FIGS. 10A-10B illustrate a computational fluid dynamics visualization of a dual strut and a single strut according to embodiments of the present disclosure.

FIG. 11 illustrates a graphical representation of initial computational fluid dynamics drag results of a dual strut (left) compared to a single strut (right) according to embodiments of the present disclosure.

FIG. 12 illustrates an isometric view of a powerhead with lifting screw assemblies attached when separated from the midsection in accordance with an embodiment of the present disclosure.

FIG. 13 illustrates a side view that includes a tensioning mechanism, powerhead, part of the midsection, a belt, and a propeller shaft in accordance with an embodiment of the present disclosure.

FIG. 14 illustrates a side view of a lifting screw assembly in accordance with an embodiment of the present disclosure.

FIG. 15 illustrates a side view of a powerhead with power electronics removed and midsection top collar cut away as to not obstruct the view in accordance with an embodiment of the present disclosure.

FIG. 16 illustrates a top view of a powerhead and midsection top collar with the power electronics removed in accordance with an embodiment of the present disclosure.

FIG. 17 illustrates a power electronics portion of an electric outboard motor in accordance with the disclosed subject matter.

FIG. 18 illustrates a power transmission assembly in side view in accordance with the disclosed subject matter.

FIG. 19 illustrates an orthogonal view of two drive shafts and sprocket assemblies in accordance with the disclosed subject matter.

FIG. 20 illustrates a side view of a powerhead portion of the power transmission assembly in accordance with the disclosed subject matter.

FIG. 21 illustrates a powerhead assembly removed from the midsection top collar in accordance with the disclosed subject matter.

### DETAILED DESCRIPTION

The present disclosure details the components and their benefits that comprise a system of modular fairings for an outboard motor. The fairings of an outboard motor include any component affixed to the main structure of the outboard. This includes, but is not limited to, a nose cone at the leading edge of the lower unit. A skeg that protrudes below the lower unit, a tail cone that affixes to the rear of the lower unit, a prop cone that affixes aft of the propeller, onto the propeller shaft. This system of modular components is designed such that equivalent components can be interchanged with the goal of optimizing the propulsion system for different use case applications. Parameters that can be changed between components include, the length of the skeg, the outer contour of the nose cone and tail cone and the diameter and shape of the prop cone. In some embodiments, additional cooling elements can be added to the system to increase the thermal dissipation capabilities of the system.

The drag on the submerged portion of an outboard motor opposes the thrust generated by the propeller. The relationship between the speed of the object and the drag created is not a linear relationship and is highly dependent on the frontal area size, shape and orientation to the flow of water. The leading edge and trailing edge work in conjunction with each other to transmit a high energy flow across the propeller while minimizing the drag. Using a modular design, the nose cone and tail cone can be changed together or separately to modify the flow that is reaching the propeller. Variations include but are not limited to, changes in the focal point and radius of the curve to optimize the drag effect for a certain flow velocity. The tail cone works in conjunction with the nose cone to bend the flow to meet the propeller blades in a continuous high energy flow path. A modular tail cone allows the torpedo to optimize the flow for different hub diameters. The present disclosure enables one propulsion system to operate at higher efficiency across multiple different operational profiles.

The powertrain of an outboard motor generally includes a prime mover, such as a combustion engine or electric motor, a vertical drive shaft, bevel gear, clutch, and propeller shaft (to which a propeller is attached). Bevel gears are gears between two intersecting shafts where the tooth-bearing faces of the gears are conical in shape. Bevel gears offer higher efficiency than other gear options and may allow for a gear reduction between the intersecting shafts. A clutch is used to allow the prime mover to operate in a single direction but also may allow the propeller shaft to rotate in both clockwise and counterclockwise directions. In various embodiments, outboards may use a dog clutch to switch between forward, neutral and reverse. This requires engaging and disengaging the shifting gears, leading to expedited wear on the teeth of the gear. To minimize this wear, the entire assembly may be submerged in an oil or lubricant that can be harmful to the environment and difficult to dispose of. Heat dissipation from key components including but not limited to, the prime mover, gears and bearings may be integral for reliable operation of this type of outboard motor. Outboard motors may ingest fluid (e.g., sea water) from the body of fluid (e.g., the sea) in which it operates to circulate the fluid around the system and cool components. However, this external fluid intake can bring in contaminants, including but not limited to salt, sand, and/or dirt that can expedite the wear and corrosion process. In some embodiments, the prime mover may be housed within the lower unit, below the water line. This configuration brings advantages with simplicity but may limit heat transfer capability. In various embodiments, other means of power transmission in place of a vertical drive shaft and bevel gears include, for example, chain-driven and belt-driven systems. In various embodiments, synchronous belts may be strong and durable, enabling potential use in higher power marine engine transmissions. In various embodiments, implementation of such belt or chain (in various embodiments, called “power transmission component”) technologies may present challenges in physical housing arrangements and mechanical assembly as frontal area and hydrodynamic shape of submerged portions of marine propulsion systems greatly affects system drag and efficiency.

Accordingly, marine propulsion systems are needed that are optimized for belt-driven and chain-driven motors while reducing drag (e.g., improving hydrodynamic qualities) and improving heat dissipation. Embodiments of the present disclosure are intended to address the above challenges as well as others.

In various embodiments, a sterndrive or outboard marine propulsion system includes a prime mover that transmits power to a driven shaft through a synchronous belt, an anti-ventilation plate, a lower unit housing, one or more skegs extending from the bottom of the lower unit housing, and a set of struts (e.g., two struts) that connects the lower unit housing to the anti-ventilation plate and attachment point on the cowling (and/or frame structure within the cowling). In various embodiments, the set of struts may be substantially aligned (e.g., parallel) with one another. In various embodiments, each strut may include one or more (e.g., a plurality) of removably attachable and modular trailing edge pieces. In various embodiments, removably attachable trailing edge pieces may allow for fine tuning of hydrodynamic properties.

In various embodiments, the attachment point connects the midsection to the lower unit and prime mover in the embodiment of an outboard marine propulsion system or connects the lower unit and outdrive in the case of a sterndrive marine propulsion system. In various embodiments, particular variables of the system enable lower drag, higher performance, and efficient accommodation of belt drive technologies. In various embodiments, components of the marine propulsion system may be modular, replaceable, and/or built such they have integrated cooling channels. In various embodiments, integration of heat dissipation functionality into a multi-strut (e.g., dual-strut) architecture may provide increased surface area from the multiple struts to optimize heat transfer capability. In various embodiments, multiple struts (e.g., two struts) increases the surface area of the struts in contact with water, thereby improving heat transfer (e.g., conduction) with the water (similar to the heat transfer of fins).

In various embodiments, frontal area and hydrodynamic shape of submerged portions of marine propulsion systems may affects system drag and efficiency. Reducing the drag on a marine propulsion system has direct improvement on the net efficiency of the system. In various embodiments, as the set of struts may be submerged when in use, the set of struts may have any suitable hydrodynamic shape to thereby reduce and/or optimize drag. For example, each strut may include an airfoil shape where the leading edge of the airfoil corresponds to the leading side of the strut.

When in operation, a belt generally has a tight side and a slack side. In various embodiments, the belt may be isolated (i.e., sealed) from the surrounding body of water in which the motor operates. In various embodiments, both sides of the belt may be supported to provide tension to the belt. In various embodiments, providing tension to the belt may reduce (e.g., stop) contamination from the surrounding water. In various embodiments, the marine propulsion system may include, among other things, a continuous loop power transmission device. For example, the prime mover may be mechanically (e.g., rotationally) coupled to the propeller via a belt or chain.

In various embodiments, each strut may be positioned at a predetermined distance from one another to thereby allow fluid flow between the struts. For example, in a dual-strut arrangement, the struts may be positioned about 2 to about 24 inches from one another. In various embodiments, the struts may be positioned about 1.5 to 6 inches from one another. In various embodiments, in larger applications (e.g., yachts, tugboats, etc.), the struts may be positioned several feet apart. In various embodiments, the struts may be positioned up to about 12 feet apart. In various embodiments, the spacing of the struts may be dependent on one or more performance factors, such as, e.g., (1) hydrodynamic interactions between the struts and/or (2) hydrodynamic drag of the lower unit. In various embodiments, as struts become wider, fewer fluid interactions may occur between the multiple struts (interference). In various embodiments, wider struts may improve certain performance factors. In various embodiments, the size (e.g., drag area) of the lower unit may be minimized to thereby minimize drag. In various embodiments, the size of the lower unit may be minimized by providing a small frontal area of the lower unit. In various embodiments, the size of the lower unit may be proportional to the size of the struts. For example, for wider struts, a larger lower unit may be provided. In various embodiments, the struts may not be parallel. For example, the struts may be non-linear or disposed at an angle (e.g., a ‘V’ shape) with respect to the horizontal (sea level).

In various embodiments, each strut may include a cross-sectional profile of the vertical struts that minimizes the drag through water. In various embodiments, the cross-sectional profile may reduce (e.g., minimize) the drag area while allowing for enough void space to house the continuous loop (e.g., belt or chain). In various embodiments, each strut may include an airfoil shape. In various embodiments, any struts (e.g., some or all struts) may have a substantially uniform shape along its length. In various embodiments, any struts (e.g., some or all struts) may have a varying shape along its respective length. For example, a strut may taper, from the leading to trailing edges, from a wider airfoil (having a higher drag area) to a thinner airfoil (having a lower drag area) or vice versa. In various embodiments, any struts (e.g., some or all struts) may have a substantially uniform width (in the direction of flow) along the length of the strut. For example, an airfoil shape may have a substantially similar (e.g., equal) chord length and/or camber line along the entire length of the strut. In various embodiments, any struts (e.g., some or all struts) may have a varying width (in the direction of flow) along the length of the strut. For example, an airfoil shape may have a varying chord length and/or camber line along the entire length of the strut. The struts can have mirroring shapes that are symmetrical about a central axis passing through the struts; alternatively, each strut can be formed with a unique shape/profile relative to the adjacent strut.

In various embodiments, each strut may include separate void spaces configured to house each side of the continuous loop (i.e., the slack side and the taut side). In various embodiments, the separate void spaces within either one or all of the vertical struts may be configured to transfer fluid (e.g., a heat transfer fluid) throughout the outboard.

In various embodiments, one or more of the struts may include a parting line to thereby separate the strut into two or more pieces. In various embodiments, parting lines allow for ease of access so that a continuous loop (e.g., chain or belt) may be installed or removed during or after manufacture (e.g., for repairs). The parting line(s) can be extend along the entire portion of the strut (e.g. between nose cone and anti-ventilation plate).

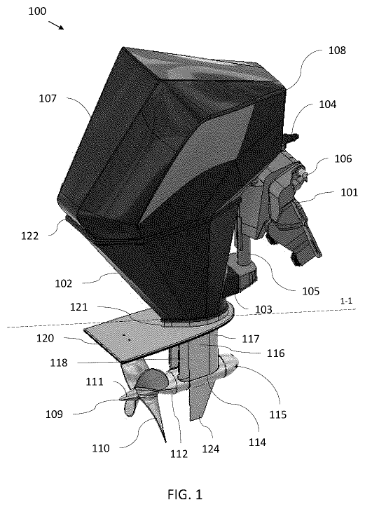

FIG. 1 illustrates an isometric view of an outboard marine propulsion system 100. In various embodiments, the marine propulsion system 100 (e.g., an outboard motor) may include a powerhead section, prime mover cowling, belt drive, anti-ventilation plate, dual strut transmission housing, lower unit with propeller, and skeg. In various embodiments, the outboard marine propulsion system 100 includes a mount 101 configured to releasably couple the transom of a boat to the outboard midsection 102 via a transom mount pad 103. In various embodiments, the outboard motor may be steered through a variety of methods, including but not limited to cables, pulleys, hydraulic and/or electromechanical actuators that mount to the steering bracket 104 and rotate the outboard motor around an axis of the steering tube 105. In various embodiments, the angle of the outboard motor, and thus the angle of propulsion, can also be controlled around the tilt axis 106. In various embodiments, the prime mover components, whether electrically or liquid fuel powered, are located underneath the top cowling 107. In various embodiments, a side of the cowling 107 facing the transom of the boat may include a face plate 108. In various embodiments, the drive shaft of the prime mover is connected via a synchronous drive belt (not shown) to the propeller shaft 109. In various embodiments, the synchronous drive belt, in turn, drives the propeller 110, creating momentum to propel the boat on which the marine propulsion system 100 is affixed. In other embodiments, the propeller may be replaced by an impeller, waterjet, or other propulsive device. In this embodiment, a propeller tail cone 111 and tail fairing 112 match the geometric profile of the propeller to minimize turbulent losses and maximize efficiency. In other embodiments, the propeller tail cone 111 and tail fairing 112 shapes can be adjusted to match different propellers. A sprocket (disposed inside the lower unit) is concentrically mounted to the propeller shaft 109 and housed inside the lower unit 114. In various embodiments, the lower unit 114 may include a nose cone 115 on a leading portion thereof. The one or more struts 116 provide an open pathway for the belt to transmit power from a sprocket attached to the prime mover under the top cowling 107 to the sprocket on the propeller shaft 109. The separate struts 116 bodies allow for the belt to operate without additional rolling components, enabling the highest possible efficiency. The one or more struts 116 are spaced in such a way that the belt does not need to be guided around obstacles or shapes as it has been required to do so in prior art. The strut bodies have hydrodynamic strut leading edges 117 and strut trailing edges 118 that reduce drag and maximize laminar flow to the propeller 110. The struts 116 connect to the anti-ventilation plate 120, which is fastened to the midsection bottom collar 121. This, in turn, fastens to the bottom of the midsection. In various embodiments, a midsection top collar 122 may provide an interface between the midsection 102 and the top cowling 107. In various embodiments, one or more skeg 124 is disposed below the lower unit. In various embodiments, where two or more skegs are provided, each skeg may be positioned equiangularly around the lower unit 114, and located upstream of the propeller.

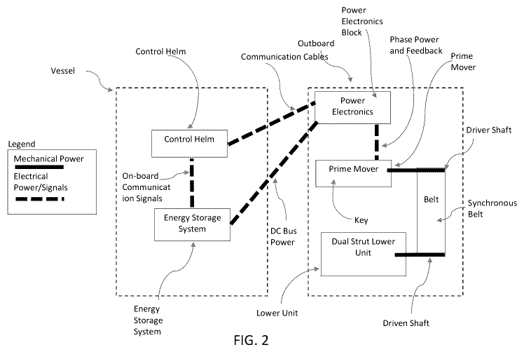

FIG. 2 illustrates a block diagram 200 representing component level interactions between the propulsion system as a whole and the dual strut lower unit. Component blocks are generally located in either the vessel or in the outboard, and are connected either mechanically or electrically as indicated by the legend. In various embodiments, the operator controls the system via the control helm, which uses on-board communication signals to interface with the energy storage system and additional communication cables to interface with the power electronics in the outboard. Communication protocols including, but not limited to, serial, CANbus, SPI, analog, and digital could be used. In various embodiments, the Energy Storage System is connected to the power electronics block through a DC Bus. In various embodiments, the DC bus may range from 12V to over 900V. In various embodiments, the power electronics block generally encompasses all power stage and control components required to use DC voltage to drive a prime mover. In various embodiments, based on signals from the control helm, the power electronics may pull energy from the Energy Storage System through the DC Bus and control the prime mover. In various embodiments, the prime mover may be an electric motor, through Phase Power and Feedback signals. In various embodiments, the prime mover is mechanically coupled through a driver shaft to the synchronous belt. In various embodiments, the belt rotates a driven shaft located inside the lower unit to thereby power a propeller.

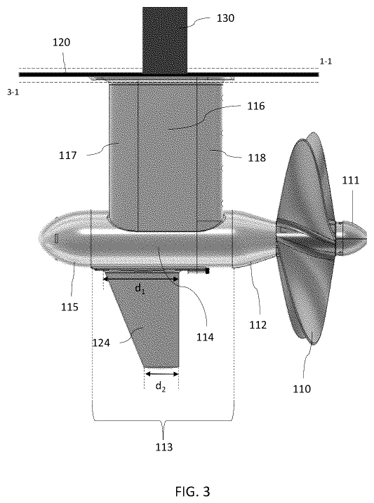

FIG. 3 illustrates a partial side view of the dual strut and lower unit bullet architecture taken generally below the line 1-1 of FIG. 1. Line 1-1, in some embodiments, is the water line of the outboard during operation. When in operation, all components below the waterline 1-1 are submerged and contribute to the hydrodynamic drag of the system. As described in the background, sterndrives and outboard marine propulsion systems may use single strut housings that connect gearcases to powerheads. Additionally, nearly all combustion outboards use a shaft and bevel gear system to transmit power from the combustion or electric powerhead to the propeller. In that type of lower unit, a mechanical mechanism is required for switching from forward to neutral to reverse. This type of power transmission requires consistent maintenance for lubricating the gears, wears quickly because of shifting at non-zero rotational speed, and may result in a 15% efficiency loss. The bevel gears also generate significant noise.

Recent advancements in material technologies have enabled the development of more robust synchronous belt drives which have the potential to increase efficiency, decrease noise, reduce maintenance, and lower cost. The present disclosure enables the use of a synchronous belt in a marine propulsion system, through a multi-strut body arrangement where each side of the belt travels through a different strut. Additionally, the present disclosure also provides a method for using electronic reversing from an electric prime mover, thereby eliminating the need for a complex mechanical shifting solution.

In various embodiments, the multi-strut design minimizes fluid flow obstruction to the propeller while moving. In various embodiments, the multi-strut (e.g., dual-strut) design reduces drag-inducing frontal area (i.e., the drag area) while increasing robustness of the entire system. In various embodiments, the strut 116 and anti-ventilation plate 120 interface is integrally formed. In various embodiments, the strut 116 and anti-ventilation plate 120 interface is mechanically fastened (e.g., with bolts and nuts). In various embodiments, the bottom of the struts may be integrally formed with the lower unit 114. In various embodiments, the lower unit 114 may be bullet-shaped (a bullet+bullet casing). In various embodiments, a first portion (e.g., the taut side) and a second portion (e.g., the slack side) of a synchronous belt 130 is protected from water and/or external fluids inside a void space within first and second struts 116. Thus the belt 130 extends (vertically when in operation) through the first strut 116, into the lower unit 114, where it engages and drives the propeller 110 forward/reverse), and up through the second strut 116, and back into the cowling 107.

In various embodiments, drag may be reduced through hydrodynamic shapes applied to the leading edges 117 and trailing edges 118 of the struts 116. In various embodiments, convex surfaces on the sides of the struts 116 between the leading edges 117 and the trailing edges 118 reduce form drag and wave creation. In various embodiments, the profile of the convex surfaces does not have to be symmetric between struts and could be changed for different applications (i.e., not all struts have to be identical in shape). In various embodiments, struts 116 may be reflections of one another (e.g., a first strut may be a reflection of a second strut). In various embodiments, the sides of the struts 116 may be substantially parallel and of equivalent lengths. In various embodiments, the struts could be non-parallel. In various embodiments, the space between the struts may increase or decrease over the height of the struts.

In various embodiments, the sides of the struts 116 may have no concavity. In various embodiments, the leading edges 117 can be integrally formed with the strut 116. In various embodiments, the leading edges 117 may be separately manufactured and removably fastened to the strut 116. In various embodiments, the trailing edges 118 may be integrally formed with the strut 116. In various embodiments, the trailing edges 118 may be separately manufactured and removably fastened (e.g., with a screw, bolt, etc.) to the strut 116 via, for example, a strut attachment point. In various embodiments, the leading edges 117 and/or the trailing edges 118 may be modular and swappable for performance optimization. Additionally or alternatively, the strut(s) can include an access panel to allow repair and inspection of the belt. The access panel can be spaced from the leading/trailing edge and located within the generally planar section of the strut(s).

In various embodiments, the strut(s) may include active control of surface shapes of the leading and/or trailing edges during operation. For example, an electronic control (e.g., real time or manual) may change a camber or chord length of an airfoil shape. In another example, an electronic control (e.g., real time or manual) may change a width (e.g., drag area) of an airfoil shape such that the continuous loop (e.g., belt) has enough room to operate in the void space.

Further aiding in hydrodynamic drag reduction and increasing propulsive efficiency is the overall shape of the architecture. In various embodiments, incoming fluid flow interacts with the nose cone 115 first. In various embodiments, the nose cone 115 geometry may be designed with a smooth transition from the nose cone 115 over the nose cone/lower unit interface and to the lower unit 114. In various embodiments, the nose cone 115 is removable and swappable. In various embodiments, the nose cone 115 may include any suitable shape. For example, the nose cone 115 may include a blunt bullet-like shape. In various embodiments, a center body 113 of the lower unit 114 may have a substantially cylindrical shape (e.g., a bullet casing shape). In another example, the nose cone 115 may be substantially conical with a sharper point. In various embodiments, as fluid flow passes the lower unit 114, the tail fairing 112 may minimize loss-inducing boundary layer separation over the tail fairing/lower unit interface as boundary layer separation may cause turbulent flow thus increasing pressure drag on the propulsion system 100. In various embodiments, the tail fairing 112 is shaped such that the tail fairing/propeller hub interface hydrodynamically meshes with the propeller hub to optimize flow entering the propeller. Thus, the struts 116, lower unit 114, nose cone 115 and tail faring 112 can be configured with a virtually seamless design in which there are no abrupt changes in size/shape/diameter, with the assembly of these components forming a continuous outer surface area to minimize drag.

In various embodiments, the tail fairing may be a frustoconical shape tapering from a larger diameter at the center body 113 to a smaller diameter at the propeller 110. In various embodiments, as the propeller 110 spins and generates regions of high and low pressure, flow is directed over a propeller tail cone 111 to reduce turbulent flow and thus further minimize drag on the propulsion system 100. In typical combustion-type marine engines, engine exhaust is generally directed down through a singular piece and out through the center of the propeller. The present disclosure eliminates this style of exhaust and allows for a more efficient overall hydrodynamic approach.

In various embodiments, one or more skeg 124 may be attached to the center body 113 of the lower unit 114. In various embodiments, the center body 113 may include one or more skeg attachment points configured to allow attachment of one or more skegs 124. In various embodiments, the skeg 124 may have a generally fin-like shape. In various embodiments, the skeg 124 may have a constant thickness along its length. In various embodiments, the skeg 124 may have a varying depth along its length. For example, the skeg 124 may taper from a first, larger depth, d₁, to a second, smaller depth, d₂. In various embodiments, one side of the skeg 124 may be vertical while the other side tapers. In various embodiments, both sides of the skeg 124 may taper. In various embodiments, the skeg 124 may have a curvilinear or airfoil shape, similar to the struts 116. In various embodiments, the skeg 124 is removable and replaceable at the skeg/lower unit interface. In various embodiments, the skeg 124 can be integrally formed at the skeg/lower unit interface. In various embodiments, the skeg 124 contributes to stability and hydrodynamic flow interaction by having a trailing edge that minimizes flow disturbances going into the propeller 110. In various embodiments, the bottom-most edge of the skeg 124 may be lower than the blades of the propeller 110, providing protection to the propeller 110 from physical object strikes. Additionally or alternatively, the location of the skeg 124 can be adjusted up/down stream relative to the lower unit 114.

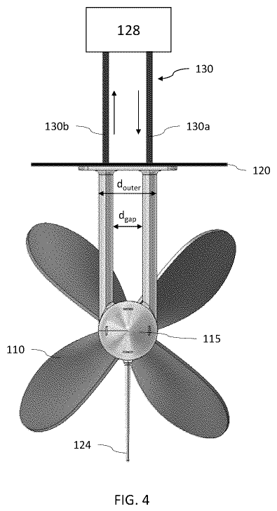

FIG. 4 illustrates a partial frontal view taken generally below the line 1-1 of FIG. 1. As shown in FIG. 4, the prime mover 128 is rotationally coupled to the belt 130 via a drive shaft (not shown). As the prime mover rotates, either the left side 130a of the belt 130 or the ride side 130b of the belt 130 may transmit rotational force to and from the propeller. In the example shown, where the belt 130 is rotating counter-clockwise (from the viewpoint of the prime mover 128), the left side 130a of the belt is the slack side and the right side 130b of the belt 130 is the taut (i.e., in tension) side. In various embodiments, the width of the gap between the two struts 116 (as measured by the distance between the inside edges of each strut) allows for passage of fluid (e.g., sea water) and can be changed to accommodate larger or smaller overall component dimensions, while keeping the ride side 130b of the belt 130 and left side 130a of the belt 130 parallel with one another. In various embodiments, the distance, d_{gap}, between the inside edges of the struts 116 can be varied based on ideal performance metrics, e.g., to reduce frontal (drag) area. In various embodiments, the distance, dₒᵤₜₑᵣ, between the outside edges can also be varied, for example, to accommodate thicker pitched belts. In various embodiments, the strut/lower unit interface may have a gradual, hydrodynamic shape to minimize flow disturbances as water travels through the struts 116 to the propeller 110. In various embodiments, the propeller 110 may be placed in front of the struts 116. In various embodiments, the anti-ventilation plate 120 may connect to the top (i.e., a proximal end) of the struts 116 and may prevent the propeller from sucking air from the surface. The anti-ventilation plate may be referred to colloquially as a “cavitation Plate”. The upper end of struts 116 can connect directly to the cowling 107; additionally or alternatively, the upper end of struts 116 can connect to a mounting plate/frame which receives the cowling 107.

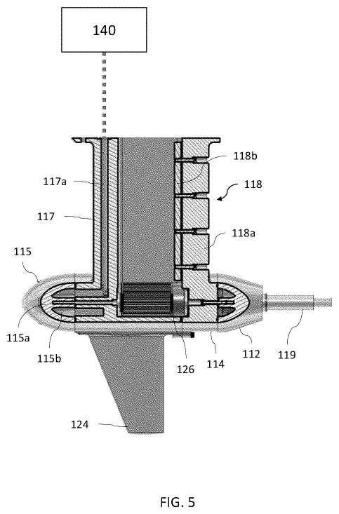

FIG. 5 illustrates a partial side view, partially in section, taken generally below the line 3-1 of FIG. 3. In various embodiments, the sprocket 126 is concentrically fixed to the propeller shaft 119, which exits the lower unit bullet through the tail fairing 112. In various embodiments, the inside of the lower unit 114 is protected from sea water through seals on all edges and interfaces, including a set of shaft seals. In various embodiments, both leading edges 117 of the struts 116 contain coolant passages 117a to allow coolant to flow therethrough. In various embodiments, coolant can enter each strut through a coolant port, then flow through the coolant passages 117a, which removes heat from the coolant through conduction. Thus, the present disclosure provides a closed-circuit fluid cooling system, wherein the coolant circulation path is retained within the struts 116, nose cone 115 and anti-ventilation plate 120. Thus the coolant system does not need to rely on the intake of ambient water when in operation. In various embodiments, the coolant passage(s) 117a of each strut allows coolant to flow into a nose cone void 115a, which acts as a submerged, heat rejecting reservoir. In various embodiments, the nose cone void 115a contains one or more nose cone turbulators 115b (e.g. undulating structure/wall/strip) configured to increase turbulence of the heat transfer fluid and thus increase heat rejection capacity. Optionally, coolant passages 117a can extend throughout the anti-ventilation plate 120.

In various embodiments, coolant can flow bi-directionally through the struts 116 and to the thermal circuit 140 via the coolant passage 117a. In various embodiments, the coolant passage 117a may comprise tubing, hosing, pipes, and/or other methods of fluid transfer. In various embodiments, the thermal circuit may include an electronic controller pump and/or heat producing components including but not limited to the power electronics and prime mover. In various embodiments, a set of coolant port seals ensures the heat transfer fluid does not become contaminated. In various embodiments, additional voids may be provided in the trailing edge(s) 118, belt accommodation void 131, tail fairing 112, and/or lower unit 114 that can be used for additional coolant passages. In various embodiments, the longitudinal width of the belt accommodation void 131 can be varied for belts of different sizes. In various embodiments, the trailing edge 118 may be mechanically fastened by a set of trailing edge fasteners 118a configured to anchor into an anchor panel 118b (e.g., a T-block). In various embodiments, this method of attachment allows the trailing edges 118 to be separated from the struts 116 for installation and removal of the belt 130. In various embodiments, the belt accommodation void 131 may be optimized such that the size (e.g., width of the void space) of the void is minimized. In various embodiments, less void space may be better from a hydrodynamic standpoint (e.g., less drag area). In various embodiments, the belt accommodation void 131 may be about ⅛ inch on either side of the belt 130. In various embodiments, the sprocket gap 125 may have a similar ⅛″ gap. In various embodiments, the sprocket gap 125 may be smaller than the space between the belt 130 and an interior side of the belt accommodation void 131 as the belt may not have as much motion around the sprocket 126. In various embodiments, the belt accommodation void 131 may include a spacing (e.g., width) of about 0.01 inch to about 0.25 inch on either side of the belt. For example, 0.25 inch on either side of the belt 130 would result in 0.25 in+0.25 in +belt thickness (in inches) for the total width of the belt accommodation void 131. In various embodiments, the belt accommodation void 131 may include a spacing (e.g., width) of about 0.01 inch to about 6 inches on either side of the belt. In various embodiments, the spacing may scale with system size. In various embodiments, the spacing (e.g., width) may be about 12 inches on either side of the belt.

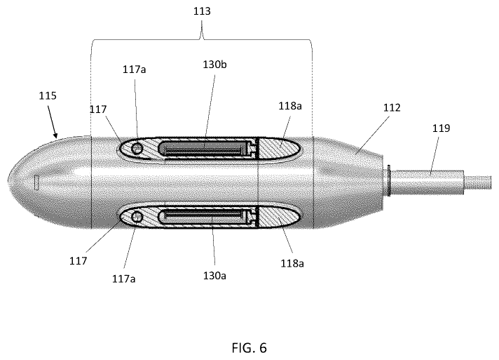

FIG. 6 illustrates a partial top view, partially in section, taken generally below the line 3-1 of FIG. 3. In various embodiments, the nose cone 115 has an outer contour that maintains an attached flow (e.g., reduces/prevents boundary layer separation) with the surrounding fluid body. In various embodiments, the nose cone 115 has a conical shape. In various embodiments, the nose cone 115 may be blunt or rounded at the tip. In various embodiments, the contour can be changed to suit different operating conditions. In various embodiments, the lower unit 114 may be cylindrical in shape and connected to both struts. In various embodiments, the trailing edges 118 may be connected to the struts 116 through fasteners anchored into the T-block 118b. In turn, the T-block is held by the walls of the dual strut bodies. In various embodiments, the leading edges 117 may include a coolant passage 117a having a circular diameter. In various embodiments, the coolant passage 117a may have a substantially constant diameter throughout the thermal circuit 140.

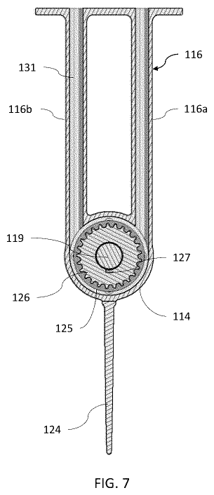

FIG. 7 illustrates a partial frontal view, partially in section, taken generally below the line 3-1 of FIG. 3. As shown in FIG. 7, the lower unit 114 and struts 116 include a belt accommodation void through which the belt 130 may pass. In various embodiments, the struts 116 include a strut inside wall and strut outside wall. In various embodiments, the strut inside wall and strut outside wall may be made of any suitable material, and can, but are not required, to be integrally formed with the rest of the strut body. In various embodiments, the thickness of the strut walls may be selected based on the application, either to increase robustness or decrease drag. In various embodiments, within the lower unit 114, the belt-driven sprocket 126 is concentric with the propeller shaft 119. In various embodiments, a keyway 127 is used to transmit torque between the sprocket 126 and propeller shaft 119. In various embodiments, a spline could be used or the sprocket 126 and propeller shaft 119 can be integrally formed. In various embodiments, to accommodate the thickness of the belt 130, an air-filled sprocket gap 125 exists in the lower unit 114. In various embodiments, due to the dual strut configuration, the belt 130 is able to rotate about the sprocket 126 without physically contacting any other part of the lower unit 114. In various embodiments, this contact-free operation allows for lubrication-free operation, compared to other motors which requires the belt or transmission components to operate in an oil-filled bath. The belt 130 can wrap around the sprocket 126, with engagement between respective surfaces over approximately 180 degrees of rotation of the sprocket. The sprocket 126 can include raised teeth, as shown, to increase the frictional engagement with the belt and generate greater torque.

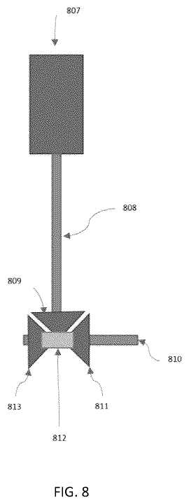

FIG. 8 illustrates a schematic representation of a traditional outboard power transmission system. In various embodiments, this utilizes a prime mover 807 with a vertically extending drive shaft 808. In various embodiments, power is transmitted from the vertical drive shaft and the horizontal prop shaft using gears. In various embodiments, a pinion gear is used 809 in conjunction with a crown gear 811 and 813 to transfer rotational velocity to the driven shaft. In many embodiments, a clutch is used with a sliding collar 812 that can engage either the clockwise or counter clockwise crown gear. In various embodiments, this mechanism enables a change in the rotation direction of the propeller shaft while maintaining drive direction of the prime mover.

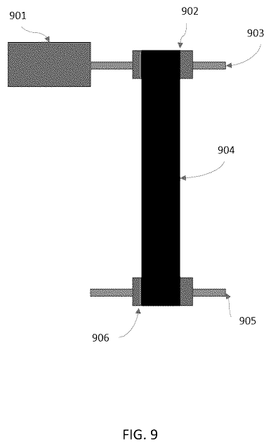

FIG. 9 illustrates a schematic representation of a belt drive transmission system. In various embodiments, this is a schematic representation of a certain embodiment for an alternative means of power transmission between a prime mover 901 and the lower driven shaft 905. In various embodiments, the prime mover utilizes a drive shaft extending horizontally 903, supporting a sprocket or gear 902, capable of driving a belt to the lower sprocket or gear 906 via a continuous loop 904.

In various embodiments, any struts may include non-linear shapes. In various embodiments, to accommodate a non-linear shape, the belt may remain substantially straight, but and the width of the belt accommodation void 131 (space between the belt and inside walls of the strut voids) may vary. In various embodiments, the struts may include pulleys (e.g., roller pulleys) configured to create a curve for the belt 130 to follow. In various embodiments, low friction pads can be positioned at any suitable position within the belt accommodation void 131. In various embodiments, any combination of the above three methods could work together to achieve a non-linear strut shape. In various embodiments, the leading edge of the struts may include a non-uniform profile (viewing from the top-down).

The various components disclosed herein (e.g., struts, nose cone, fairing, skeg) can be formed from a variety of materials including metals (e.g., aluminum, steel, titanium, etc.) rigid polymers and plastics, wood, etc. In various embodiments, the various components may include composite materials (e.g., carbon fiber, fiberglass, etc.). In various embodiments, the various components may include rubber. In various embodiments, the various components may include thermoplastics. In various embodiments, the various components may include any suitable metal-based alloys. In various embodiments, the various components may include materials with high thermal conductivity and high corrosion resistance. In various embodiments, the various components may include one or more coatings (anodize, powder coat, chemical vapor deposition, paint, etc.). In various embodiments, the various components may be formed from more than one material (i.e., nose cone could be mostly aluminum with a rubber based tip).

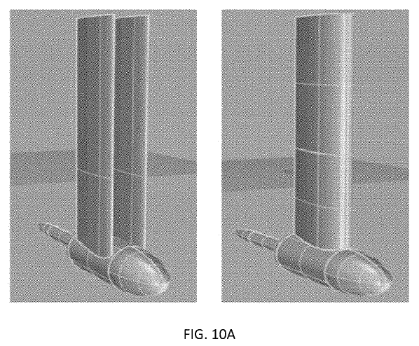

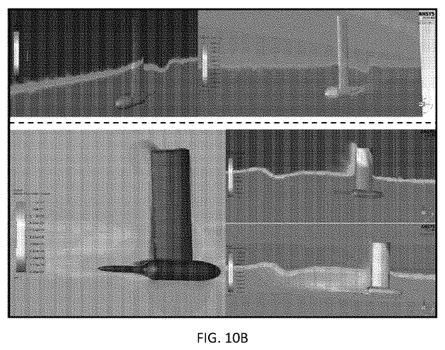

FIGS. 10A-10B illustrate a computational fluid dynamics visualization of the disclosed dual strut and a traditional single strut. In various embodiments, this half-body analysis was used to understand preliminary hydrodynamic effects and implications of a dual strut compared to a single strut. The plot of FIGS. 10A-10B shows a laminar flow as evidenced by the largely uniform shading of the fluid flowrate values (the darker portion of the plot in FIG. 10B is above the water line).

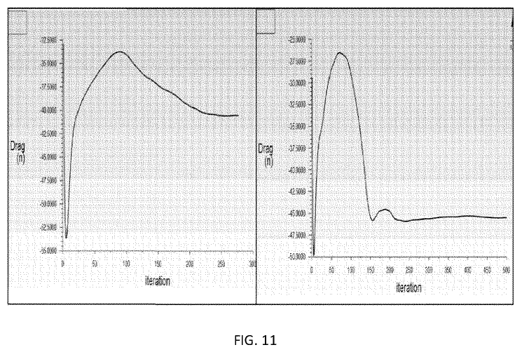

FIG. 11 illustrates a graphical representation of initial computational fluid dynamics drag results of the disclosed dual strut (left) (approximately 37,500 Newtons at iteration 150) compared to a traditional single strut (right) (approximately 45,500 Newtons at iteration 150). This simulation evidences the hydrodynamic advantages of a dual strut compared to a single strut.

In order to enable the use of a belt for power transmission between the prime mover and propeller shaft, a structure holding the prime mover is affixed to and lifted or adjusted relative to the midsection by a set of lifting screws. This structure also serves to support and align the entire powerhead, including power electronics, motor, upper belt pulley, shaft coupling, low voltage distribution, and a significant portion of the cooling system. Equal adjustment of the lifting screws allows for tensioning of the belt by moving the powerhead uniformly relative to the midsection, while uneven adjustment will tilt the powerhead, including the shafting so that it can be aligned with the propeller shaft. Removing the lifting screws entirely or freeing the powerhead from the lifting screws allows the powerhead to be separated from the midsection. At this point, any powerhead with the same lifting screw and pulley arrangement can be used assuming it fits within the outer shell of the outboard motor.

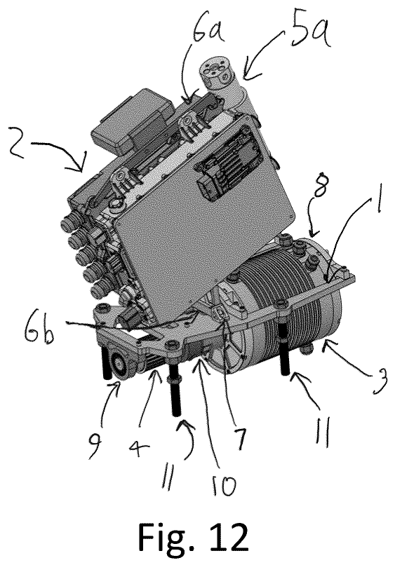

FIG. 12 illustrates an outboard engine powerhead separated from the midsection. The outboard engine powerhead may be disposed within any fairings, housing or other motor, such as in the motor depicted in FIG. 1. As shown in FIG. 12, a main lifting plate 1 supports the power electronics 2, motor 3, drive shaft assembly 4, which may be called the first drive shaft (assembly), and part of the cooling system 5. In this view of the cooling system 5, only the coolant reservoir 5a is visible. In various embodiments, the power electronics 2 and coolant system 5 are supported by a set of electronics supports 6. In this view, the upper electronics support 6a and secondary lower electronics support 6b are visible, along with one of the five brackets 7 that affix the electronics supports to the main lifting plate 1. In various embodiments, the motor may be supported by any number, arrangement or configuration of brackets suitable. In various embodiments, the motor 3 is held to the main lifting plate 1 by motor mounts 8 on the front and back. In various embodiments, the drive shaft assembly 4 is supported independently of the motor 3 by two bearing blocks 9 and is powered through a shaft coupling 10 that also attaches to the motor 3. In various embodiments, the main lifting plate 1 is supported by one or more lifting screw assemblies 11.

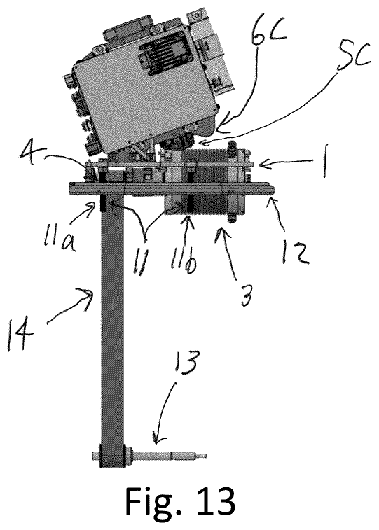

FIG. 13 illustrates a side view of the drive train of an outboard engine with various parts hidden. As shown in FIG. 13, the main lifting plate 1 is supported from the midsection top collar 12 by the lifting screw assemblies 11. In various embodiments, the propeller shaft assembly 13 can spin freely along its axis but is rigidly located with reference to the midsection top collar 12. In various embodiments, power may be transmitted from the drive shaft 4 to the propeller shaft by a belt 14 (or, alternatively, a chain). In various embodiments, the lifting screw assemblies 11 are used to move the main lifting plate 1 and attached drive shaft assembly 4. In various embodiments, because the propeller shaft 13 (which may be the same or similar to 109) is a fixed distance from the midsection top collar 12, moving the drive shaft assembly 4 relative to the midsection top collar 12 will alter the distance that the belt is required to cover, thereby adjusting tension in the belt. In various embodiments, moving the drive shaft assembly 4 relative to the midsection top collar 12 can be used to achieve the needed tension in the belt 14 as it elastically deforms to fit.

In various embodiments, lifting screw assemblies 11 may fall into two categories: primary lifting screws 11a and leveling lifting screws 11b. In various embodiments, primary lifting screws 11a may be positioned approximately in line with the belt 14 and will bear most of the force applied by tension in the belt 14. In various embodiments, leveling lifting screws 11b are placed further from the belt 14 and are configured to support and level the main lifting plate 1. In various embodiments, by adjusting the leveling lifting screws 11b separately from the primary lifting screws 11a, the angle of the drive shaft 4 can be brought into alignment with the propeller shaft 13 without significantly changing the tension in the belt 14. In various embodiments, tension in the belt is not significantly changed during levelling because the main lifting plate 1 is allowed to pivot about the primary lifting screws 11a which are in line with the belt 14. In various embodiments, the primary lifting screws 11a and leveling lifting screws 11b are provided in sets of two screws each. In various embodiments, the primary lifting screws 11a and leveling lifting screws 11b are of the same size. In various embodiments, the primary lifting screws 11a and leveling lifting screws 11b may different numbers and sizes. The coolant pump 5c and lower electronics support 6c are also visible in this view.

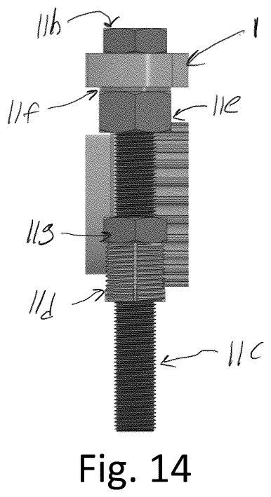

FIG. 14 shows a close-up view of a lifting screw assembly. In FIG. 14, the main lifting plate 1 and attached features are shown, while the midsection top collar 12 is hidden. In various embodiments, the threaded rod 11c runs between the main lifting plate 1 and the midsection top collar (not shown). In various embodiments, the threaded rod 11c threads into the midsection top collar (not shown). In various embodiments, a threaded insert 11d is permanently installed in the midsection top collar (not shown). In various embodiments, the threaded insert 11d is fixed to the midsection top collar (not shown) but provides a more durable fixture for the threaded rod 11c to be screwed through. In various embodiments, turning the threaded rod 11c will adjust the distance that the threaded rod 11c protrudes from the midsection top collar (not shown). In various embodiments, a large nut may be provided as a main plate support lie on the threaded rod 11c. In various embodiments, the main plate support lie bears the load applied by the main lifting plate 1, and is affixed to the threaded rod 11c in such a way that it cannot move along the threaded rod 11c. In various embodiments, because the main plate support lie is rotationally locked to the threaded rod 11c, a washer 11f is placed between the main plate support lie and the main lifting plate 1. In various embodiments, the washer 11f may be made of a polymer. In various embodiments, the washer 11f may be configured to reduce friction and prevent metal-on-metal scraping when the threaded rod 11c and main plate support 11e are rotated to adjust the height of the mail lifting plate 1. In various embodiments, a jam nut 11g may be tightened against the threaded insert 11d to prevent the threaded rod 11c from turning, therefore locking the height of the lifting screw assembly 11. In various embodiments, a cap 11h covers the top of the threaded rod 11c, holding the main lifting plate 1 in place. In various embodiments, the cap 11h prevents the main lifting plate 1 from moving upwards. In various embodiments, the cap 11h may also serve the purpose of being tightened to prevent the threaded rod 11c from spinning, or as a method of rotating the threaded rod 11c to adjust the height.

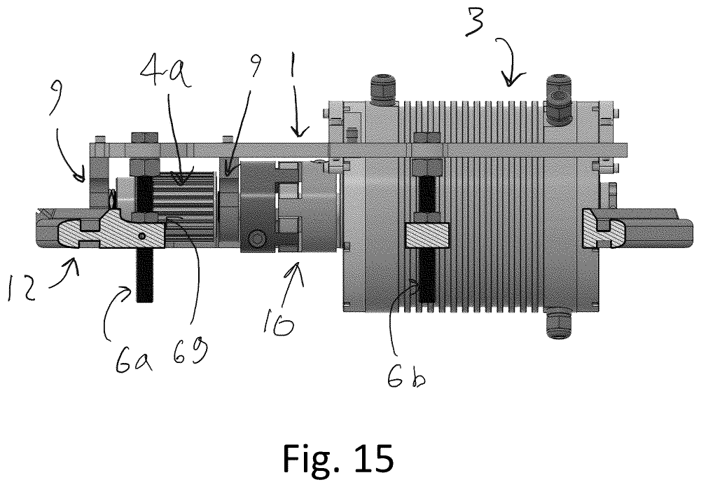

FIG. 15 illustrates a side view of an outboard engine powerhead. In FIG. 15, most of the midsection as well as the power electronics 2 are hidden, and what remains of the midsection is cut away for clarity. In various embodiments, the drive shaft assembly 4, including the upper sprocket 4a, is supported by bearing blocks 9 independently of the motor. In various embodiments, the drive shaft 4 is only rotationally coupled to the motor 3 through the shaft coupling 10. In various embodiments, the shaft coupling 10 allows for a small amount of misalignment between the drive shaft assembly 4 and the motor 3. In various embodiments, the shaft coupling also provides a point at which the motor 3 can be separated from the drive shaft assembly 4. In various embodiments, two sets of lifting screw assemblies 6a and 6b are provided (which can be operated independently, or in tandem). FIG. 15 also illustrates a jam nut 11g tightened against the threaded insert 11d (obscured by the midsection top collar 12), thereby locking the lifting screw assemblies 6 and the powerhead through the main plate 1 in place relative to the midsection top collar 12.

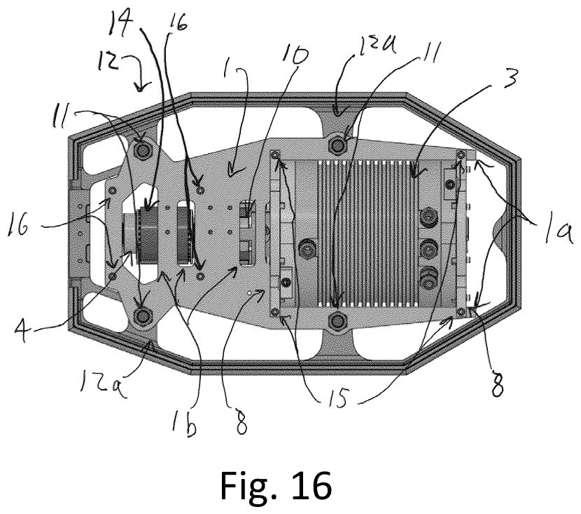

FIG. 16 illustrates a view of the powerhead and midsection top collar 12 with the power electronics 2 removed. FIG. 16 provides a clear view of several details of the midsection top collar 12 and the main lifting plate 1. In various embodiments, powerhead mounting tabs 12a extend in from the outer rim of the midsection top collar 12 to accept the lifting screw assemblies 11. In various embodiments, removing the motor mounting screws 15, which connect the motor mounts 8 to the main plate 1, allows the motor 3 and motor mounts 8 to be slid backwards, separating the motor 3 from the drive shaft assembly 4 by splitting the shaft coupling 10 in two. In various embodiments, support tabs 1a of the main plate will keep the motor 3 completely supported during this process by providing a place for the rear motor mount 8 to rest. In various embodiments, once the shaft coupling 10 is completely separated, the gap in the main lifting plate 1 may be large enough for the motor 3 to be removed. In various embodiments, this process can be done in reverse to install the motor 3. In various embodiments, with the motor 3 separated at the shaft coupling 10, either completely removed or resting on the support tabs 1a, the bearing block screws 16 can be removed to release the drive shaft assembly 4 with the bearing blocks 9 (obscured) attached. In various embodiments, the drive shaft 4 can then be passed through the belt 14 and re-attached to the main lifting plate with the bearing block screws 16. In various embodiments, the motor 3 can then be moved forward to re-connect the shaft coupling 10. In various embodiments, cutouts 1b may be formed in the main lifting plate 1 to thereby reduce the weight of the main lifting plate 1 and provide visibility and tool access for ease of maintenance.

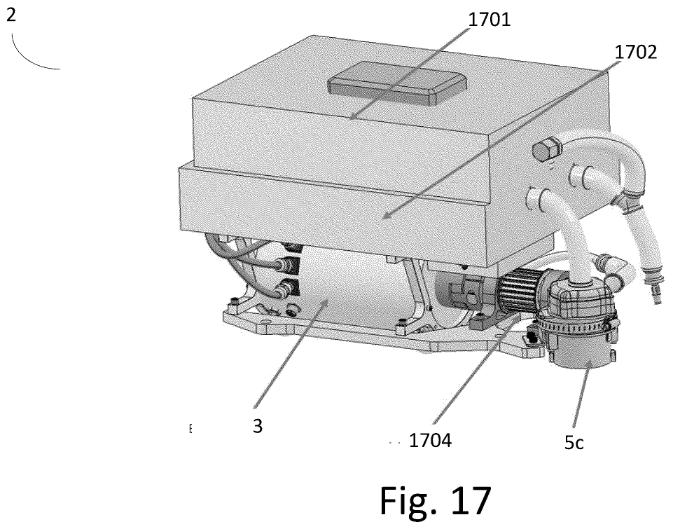

FIG. 17 illustrates a power electronics 2 portion of an electric outboard motor in accordance with the disclosed subject matter. In various embodiments, an electric outboard powerhead of an electric outboard motor maintains the functionality of transferring torque from a motor to a propeller (or another suitable propulsor)—containing all the components required to send rotational energy down to the propeller. In various embodiments, the power transmission assembly includes a charger, an inverter (motor controller), an electric motor, a coolant pump, a driveshaft, a low voltage systems, an electronic control unit (ECU), and an upper sprocket. FIG. 17 depicts an embodiment of an electric outboard motor powerhead where the electric motor 3 is oriented horizontally to avoid changing the direction of rotational motion.

With further reference to FIG. 17, power electronics 2 includes inverter 1701 and outboard controller 1702. In various embodiments, inverter 1701 and outboard controller 1702 may be included in a single component such as a printed circuit board, processor, or assembly of electronics, communicatively coupled together. Power electronics 2 includes electric motor 3 as described above, the electric motor 3 configured to turn upper sprocket 1704 which is disposed on at least a portion of the upper driveshaft assembly 4. Power electronics 2 also includes a cooling system, in FIG. 17, only coolant pump 5c. In various embodiments, the axis of the upper driveshaft 4 may be disposed parallel and coplanar with the axis of the propeller driveshaft 13.

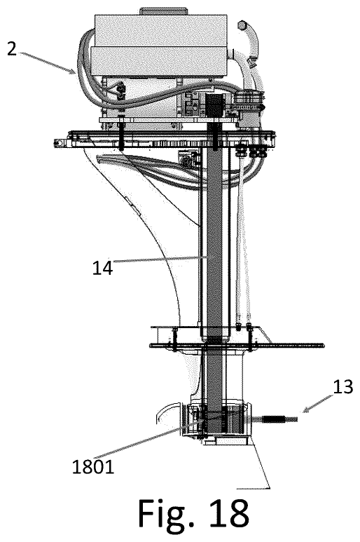

FIG. 18 illustrates a power transmission assembly in side view. To transmit horizontally oriented rotational motion to the propeller shaft, this embodiment of an outboard motor uses a power transmission belt in place of a conventional driveshaft. As illustrated in FIG. 18, the belt is looped over the upper sprocket, and runs from the powerhead to the lower sprocket on the propeller shaft. Power transmission assembly includes powerhead assembly, which includes the power electronics 2 and electric motor 3. The electric motor 3 configured to turn upper sprocket 1704. The upper sprocket 1704 is configured to rotatably and continuously transfer rotational motion to the lower sprocket 1801, disposed at the lower unit (to the left of the drawing), the lower sprocket 1801 configured to intake that rotational motion from the belt 14 and turn the propeller shaft. The propeller shaft 13 in turn turning the propeller 110 (from FIG. 4). In various embodiments, the power transmission assembly must cause a tension in the belt 14.

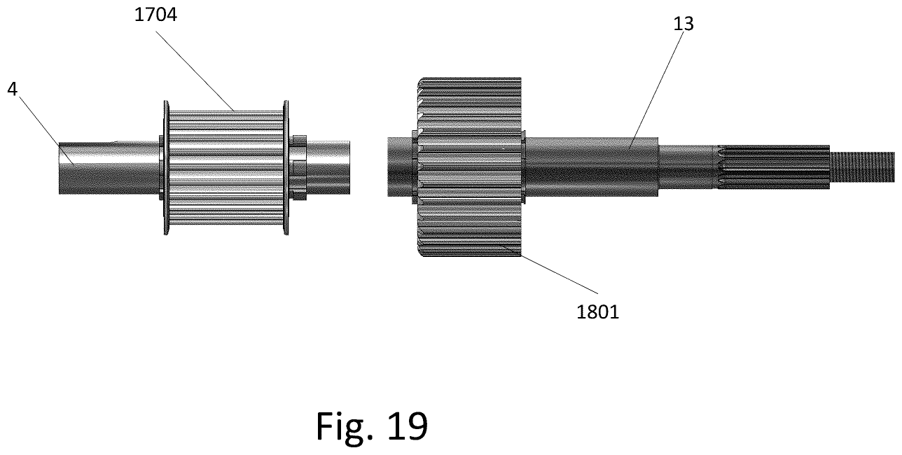

FIG. 19 illustrates an orthogonal view of two drive shafts and sprocket assemblies in accordance with the disclosed subject matter. FIG. 19 shows on the left hand side the upper drive shaft assembly 4 and the upper sprocket 1704. It should be noted that the shaft would extend leftwards to the electric motor 3, and rightwards to one or more brackets 9. The assembly is configured to turn at the rate of revolutions of the electric motor 3, the upper sprocket 1704 continuously and rotatably coupled to the belt 14 (not shown). It should be noted as well that the relative arrangement of the two shafts and sprockets are detail views only, and do not seek to limit the arrangement of these shafts and sprockets in accordance with the disclosed subject matter. Additionally, FIG. 19 depicts the lower unit's propeller shaft 13, the propeller shaft 13 having a lower sprocket 1801 affixed to a portion thereof. The lower sprocket 1801 is rotatably and continuously coupled to the belt 14 and thereby rotatably coupled to the upper sprocket 1704. The rotational motion of the upper sprocket 1704 is transferred to the propeller shaft 13 via the belt 14 (not shown in this detail view). The shafts and sprockets maintain the ability to transmit torque and rotational motion according to a gear reduction. This belt drive retains parity with its conventional driveshaft counterpart's capability to provide gear reduction by using differently sized sprockets—however, it does not necessarily have to. In various embodiments, as shown in FIG. 19 this belt drive assembly provides a 1.36:1 reduction in motor output speed reduction by using a smaller upper sprocket 1704 on the driveshaft than the lower sprocket 1801 attached to the propeller shaft 13.

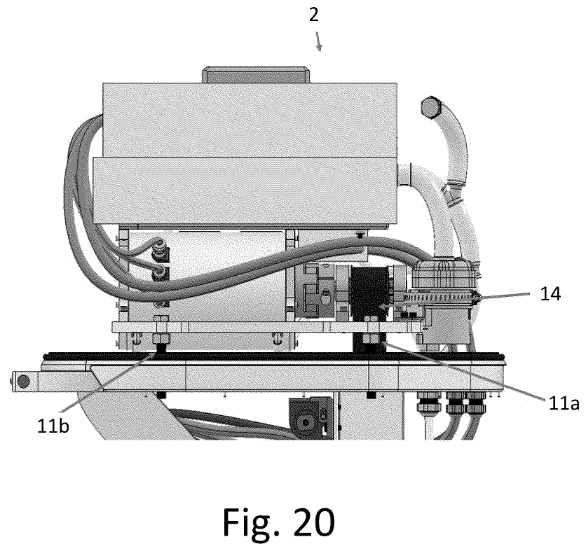

FIG. 20 illustrates a side view of a powerhead portion of the power transmission assembly. To function, the power transmission belt 14 is pre-loaded in tension so that the sprockets (1704, 1801) remain aligned. To accomplish this, the powerhead is carried by two sets of lifting screws 11. As shown in FIG. 20, the powerhead in supported in the front by a pair of alignment lifting screws 11b and in the back by a pair of tension lifting screws 11a. By adjusting all lifting screws together (in various embodiments, two sets of two, so four total), the powerhead moves straight up and down relative to the body of the outboard—and therefore relative to the propeller shaft 13 with lower sprocket 1801 (not shown). Proper preload tension can be achieved by attaining appropriate distance between the upper and lower sprockets 1704, 1801, stretching the belt. The tension lifting screws 11a are placed in line with the belt 14; adjustment of these screws on their own will have a significant impact on the tension in the belt 14. On the other hand, the alignment lifting screws 11b are farther from the belt, and adjusting these screws on their own will rotate the powerhead around the tension lifting screws 11a-adjusting the alignment of the driveshaft 4 and propeller shafts 13 with minimal impact on the pre-load tension of the belt 14. This level of adjustability helps to accommodate for any issues in the stack-up of components between the driveshaft and propeller shaft. In some embodiments the screw 11a,b can include indicia or markings to visually confirm the plate is set at an appropriate height for a given belt assembly.

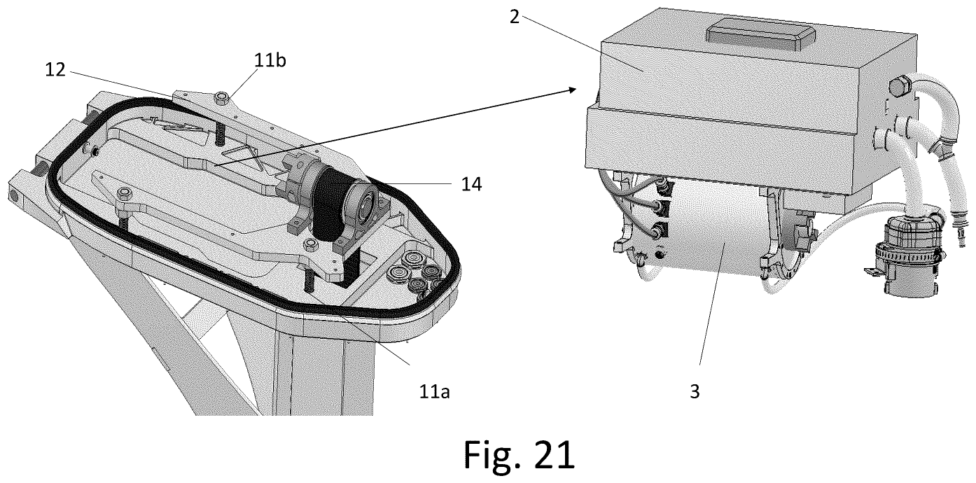

FIG. 21 illustrates a powerhead assembly removed from the midsection top collar. The ability for the power electronics 2 to be removed from the midsection top collar 12 wholesale without the removal of the upper sprocket 1704 and by extension, belt 14 improves serviceability of both the power electronics 2 and the belt drive assembly. To improve serviceability and manufacturability for this embodiment, there are several features intended to ensure that the lifting screws 11 can be left alone once set. The one of these features is featured in FIG. 21—the powerhead can be split, leaving only the driveshaft assembly 4 behind on the structure of the outboard while the power electronics 2 “suitcase” is removed. With the ability to remove the power electronics 2 without adjusting the lifting screws 11 (11a, 11b), and by extension the main lifting plate 1, the required and/or preferred tension on the belt 14, does not need to be readjusted or reset each time maintenance is required. Additionally, the removability of the power electronics 2 from the drive shaft assembly 4 allows for access to the components of said assembly and especially upper sprocket 1704 and the components to which it is coupled, namely belt 14 and bracket 9. In this state, the belt 14 retains its pre-loaded tension while other components are removed.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A marine propulsion apparatus comprising:
a first drive shaft;
a lifting plate fixed relative to the first drive shaft;
a midsection top collar;
a lower unit attached to the midsection top collar, the lower unit having a second drive shaft, wherein the midsection top collar is fixed relative to the second drive shaft;
a power transmission component rotatably coupling the first drive shaft to the second drive shaft, wherein the power transmission component is continuously disposed over the first drive shaft and the second drive shaft, the power transmission component configured to rotate about the first and second drive shafts; and
one or more lifting screws coupling the lifting plate to the midsection top collar, wherein adjusting the one or more lifting screws changes a distance between the lifting plate and the midsection top collar, thereby adjusting a tension of the power transmission component.

2. The apparatus of claim 1, wherein adjustment of the one or more lifting screws in a first direction increases the distance between the lifting plate and the midsection top collar.

3. The apparatus of claim 1, wherein the adjustment of the one or more lifting screws in a second direction decreases the distance between the lifting plate and the midsection top collar.

4. The apparatus of claim 1, wherein a longitudinal axis of the first drive shaft and a longitudinal axis of the second drive shaft comprise an angle therebetween.

5. The apparatus of claim 4, wherein one or more leveling screws are connected between the lifting plate and the midsection top collar, the one or more leveling screws configured to change the angle between the longitudinal axis of the first drive shaft and the longitudinal axis of the second drive shaft.

6. The apparatus of claim 5, wherein the one or more leveling screws are disposed at a greater distance from the belt than the one or more lifting screws.

7. The apparatus of claim 2, wherein there are two lifting screws.

8. The apparatus of claim 5, wherein there are two leveling screws.

9. The apparatus of claim 1, wherein the one or more lifting screws comprise at least one washer disposed between the lifting plate and a nut.

10. The apparatus of claim 9, wherein the at least one washer is formed from a polymer.

11. The apparatus of claim 9, wherein the nut is a jam nut.

12. The apparatus of claim 1, wherein the lifting plate may be formed with at least one cutout disposed through at least a portion of the lifting plate.

13. The apparatus of claim 1, wherein the one or more lifting screws comprise a cap threaded onto the one or more lifting screws, the cap configured to restrain the lifting plate from moving in an upward direction.

14. The apparatus of claim 13, wherein the cap is configured to rotate the one or more lifting screws on which the cap is threaded.

15. The apparatus of claim 1, wherein the power transmission component is formed as a belt.

16. The apparatus of claim 1, wherein the power transmission component is formed as a chain.

17. A marine propulsion apparatus comprising:
a first drive shaft;
a lifting plate fixed at a first distance relative to the first drive shaft;
a midsection top collar;
a lower unit, the lower unit comprising a second drive shaft, wherein the midsection top collar is fixed at second distance relative to the second drive shaft;
a power transmission component rotatably coupling the first drive shaft to the second drive shaft, the power transmission component configured to rotate the second drive shaft; and
one or more lifting screws disposed between the lifting plate and the midsection top collar, the one or more lifting screws rotatably coupled to the lifting plate and the midsection top collar, defining a third distance therebetween, wherein rotating the one or more lifting screws alters the third distance, thereby altering a tension of the power transmission component.

18. The apparatus of claim 17, wherein the rotation of the one or more lifting screws in a first direction increases the distance between the lifting plate and the midsection top collar.

19. The apparatus of claim 17, wherein the rotation of the one or more lifting screws in a second direction decreases the distance between the lifting plate and the midsection top collar.

20. The apparatus of claim 17, wherein each of the one or more lifting screws comprise a threaded rod, the threaded rod configured to mate with a threaded insert disposed within a portion of the midsection top collar.
